(19) United States
(12) Patent Application Publication
(10) Pub. No.: US 2004/0214958 A1
(43) Pub. Date: Oct. 28, 2004

(54) Use of chemically modified elastomeric polymers to improve adhesion properties of thermoset elastomeric polymers components

(76) Inventors: Eric Paul Jourdain, Rhode Saint Genese (BE); J R H. Schauder, Wavre (BE); Guy J. Wouters, Brussels (BE)

Correspondence Address: EXXONMOBIL CHEMICAL COMPANY, P O BOX 2149, BAYTOWN, TX, 77522-2149, US

(21) Appl. No.: 10/847,707

(22) Filed: May 18, 2004

Related U.S. Application Data
(63) Continuation of application No. 10/252,144, filed on Sep. 20, 2002, now abandoned.
Application No. 10/252,144 is a division of application No. 09/591,663, filed on Jun. 9, 2000, now abandoned.

(51) Int. Cl. C08F 120/08

(52) U.S. Cl. 525/327.4; 428/122; 525/333.9; 525/387

(57) ABSTRACT

Elastomeric polymers that have been functionalized are shown to provide superior extruded profiles for use in vehicle sealing systems. Generally the, polymers functionalized are the ethylene, -alpha-olefin, non-conjugated diene monomer terpolymers or ethylene, -alpha-olefin copolymers. The elastomeric polymers are functionalized with one or more of carboxylic acids, anhydrides, hydroxyl, epoxide or amine functionality. The functionalized elastomeric polymers are generally used in conjunction with non-functionalized elastomeric polymers. The functionalized elastomeric polymers provide superior adhesion to the additional components used to enhance functionality and/or aesthetics. Among the vehicle sealing systems discussed are glass run channels, inner belt line seals, outer belt line seals and door seals.

### CROSS REFERENCE TO RELATED APPLICATIONS

The present application is a continuing application from U.S. patent application Ser. No. 10/252,144 filed Sep. 20, 2002, the entire contents of which application are incorporated herein by reference.

### TECHNICAL FIELD

This invention relates generally to cured elastomeric polymer systems, including at least one elastomeric polymer that is functionalized, where the polymers are a part of a vehicle sealing system.

### BACKGROUND

Recent general trends in motor vehicles, particularly automobiles, translated into smaller size vehicles compared to the automobiles generally available during the first three quarters of the 20th century. Consumers usually perceive the quality of a car through its comfort and visual aspects. Additionally, vehicles are becoming more aerodynamically designed. These factors, among others, generally make today's motor vehicles more insulated from the outside noise, air and water ingression than earlier automobiles.

The combination of these factors leads to more sophisticated design for the elastomeric sealing systems in general around the doors and the windows, fixed or moveable. As an example, in every latitude, whether extreme low ambient temperatures or high temperature and humidity in warm climates, the sealing system has to operate nearly perfectly even after several years. Car makers suppliers have developed new methods to improve the sealing performance of the elastomeric sealing systems, like coating of silicone or polyurethane on rubber profiles, generally fabricated with compounds containing an ethylene, -alpha-olefin, diene-monomerelastomeric polymer such as, but not limited to, ethylene, propylene, diene monomer rubber (EPDM). For purposes of this specification and the appended claims, “compound” will refer to rubber or an elastomeric polymer compounded or mixed by methods well known to those skilled in the art with reinforcing filler materials, plasticizers, curatives, accelerators, and other additives well known to those skilled in the art, unless otherwise indicated. Also, to improve the visual perception inside the passenger compartment, the profile design includes portions matching the color of other plastic trim in the auto, like instrument or door panels. These colored profiles can be achieved by adhering colored plastic veneer on the typical black elastomeric profile. Elastomeric compounds for passenger compartment and door or glass seals use must first function over a broad range of temperatures and further must continue to function adequately throughout the life of the vehicle which may extend to 10 or more years or 200 thousand miles (320 thousand kilometers) or more.

In the past, most sealing systems have been manufactured from compounds based on styrene butadiene rubber (SBR) or polychloroprene (CR). Most SBR or CR compounds have performed with a limited life, since cracking and tearing were observed after few years of use under the attack of ozone and oxygen present in the atmosphere. In the recent past, because of its higher temperature resistance and its better chemical resistance to ozone and oxygen, ethylene, alpha-olefin, non-conjugated diene, elastomeric polymer based compounds have replaced the majority of the SBR and CR made parts, particularly in the body sealing applications. Most of the currently available ethylene, alpha-olefin, non-conjugated diene, elastomeric polymers contain a diene monomer where the diene monomer is well known to those of skill in the art.

The key compound requirements to manufacture a good quality profile for use as an auto sealing system include high tensile strength and high modulus, good adhesion properties to textiles and fabric, wear and abrasion resistance against the door and window when in motion, tear resistance, environmental resistance such as ozone, U.V and heat. Such a high performing compound has to have good rheological performance, high vulcanization rate and high crosslink density to insure consistent, economical and quality production. Such properties have been heretofore unavailable.

Today the new requirements of the automobile industry are in particular better insulation, longer service life and better aesthetic of the rubber part. Therefore new materials are being coated on the surface of the rubber profile. Aesthetics can be improved by addition of colored veneer based on thermoplastic rubber coextruded on the surface of the rubber carrier. Insulation can be improved by addition of a low friction coating based on polyurethane (PU) and/or silicon used in place of the flock for belt line seal and glass run channel. The adhesion of those coatings on currently available ethylene, alpha-olefin, non-conjugated diene, elastomeric polymer based compounds is generally fair to poor because of the apolar nature of the elastomeric polymer.

Currently in the manufacture of elastomeric sealing parts, the manufacturer uses mechanical or chemical surface modification to obtain the necessary adhesion on elastomeric profiles. For example, the adhesion of the flock is improved by mechanically abrading the surface of the profile before depositing the adhesive. An electrostatic treatment under high voltage discharge is used to create/increase surface polarity. The adhesion of rubber to metal is insured by an adhesive generally laid on the metal before coextrusion with the elastomeric profile. All such techniques well known by those who are skilled in the art of producing elastomeric body seals are generally expensive and complex. They are generally source of surface defects and scrap since any defect in the adhesive deposit or electric discharge treatment results in poor adhesion of the coating and rejection of the finished part after quality control.

U.S. Pat. No. 4,897,298 suggests a laminate comprising (a) a layer of partially crosslinked graft modified polyolefin elastomer formed by dynamically heat treating a mixture of a peroxide crosslinking olefin copolymer rubber and an olefinic plastic with an unsaturated carboxylic acid or derivative thereof, an unsaturated epoxy monomer or an unsaturated hydroxyl monomer in the presence of an organic peroxide and (b) a layer of a polyamide, polyurethane or polyester. This laminate is purportedly molded into an interior part or sealing material of an automobile, especially a glass run channel. The olefinic plastic is a crystalline high molecular weight solid product.

Therefore a material which displays generally a higher surface energy and can be incorporated continuously in production processes of door seals, inner and outer belt seals and metal carriers without changing the elastic characteristic and sealing performance of the part, would be highly desirable, but has been heretofore unattainable.

### SUMMARY

There is a commercial need, therefore, for an elastomer material, which, when compounded, can provide automotive sealing parts, which may be coated, with improved adhesion performance onto elastomeric profiles even after aging in hostile environments.

We have discovered that fully cross-linked sulfur cured and/or peroxide cured elastomeric polymer based compounds made including an ethylene, alpha-olefin, copolymer or terpolymer, where either copolymer or terpolymer or both are functionalized with a polar group, preferably a carboxylic acid, anhydride, hydroxyl, epoxide, or amine functionality, surprisingly and unexpectedly provides improved adhesion performance to various types of coatings, like low friction or colored coatings used to modify the characteristics of the surface of elastomeric sealing profiles and moldings in order to provide better insulation to air, water or noise, to permit better sliding of a glass against the seal or to improve the aesthetics of a car.

The functionalized ethylene, alpha-olefin, elastomeric copolymer or terpolymer can be used in the sealing part compounds as a total elastomeric base or as part of the elastomeric base in a blend with each other and/or other non-modified ethylene, alpha-olefin, elastomeric copolymers or terpolymers.

We contemplate that regardless of the elastomeric polymer or polymers in a profile compound, at least one of which must be functionalized, the profile will be fully cured. The curing will be either via sulfur, peroxide, or a combination thereof. The profile, including at least one functionalized co or terpolymer will be substantially free of crystalline polyolefin.

We contemplate a vehicle sealing system, the system including a fully sulfur or peroxide cured elastomeric polymer, the system being substantially free of crystalline polyolefin, comprising a functionalized ethylene -alpha-olefin, non-conjugated diene elastomeric terpolymer, wherein the functionality is a polar group, preferably selected from the group consisting of carboxylic acid, anhydride, hydroxyl, epoxide, and amine functionality. The vehicle sealing system may further comprise an elastomeric polymer selected from the group consisting of a non-functionalized terpolymer, a non-functionalized copolymer, and combinations thereof. The vehicle sealing system may also further comprise a functionalized ethylene -alpha-olefin, elastomeric copolymer wherein said functionality is a polar group, preferably selected from the group consisting of carboxylic acid, anhydride, hydroxyl, epoxide, and amine functionality.

The vehicle sealing system may be a glass run channel, door seal or belt line seal.

The foregoing aspects, features and advantages of the present invention will become clearer and more fully understood when the following detailed description, and appended claims are read.

### DETAILED DESCRIPTION

### Introduction

This invention concerns certain extruded and molded elastomeric polymer profiles that include at least one functionalized elastomeric polymer. The elastomeric polymer profiles will have superior adhesion to a variety of substrates, generally polar materials.

In certain embodiments of the present invention, extruded profiles of at least one functionalized ethylene, -alpha-olefin, non-conjugated diene elastomeric terpolymer, at least one functionalized ethylene -alpha-olefin copolymer, or combinations of these polymers and optionally a non-functionalized ethylene -alpha-olefin copolymer, terpolymer or combinations thereof, can be shown to have excellent adhesion to polymers which can be generally characterized as polar.

This invention further includes certain extruded elastomeric polymer profiles generally for use as a vehicle sealing system, especially such sealing systems known as glass run channel, door seal or belt line seal, the use of such sealing systems in vehicles and the vehicles containing such systems. Also contemplated is the fabrication of the glass run channel, door seal or belt line seal which may include flocking, coloring, low friction coating, thermoplastic veneer or thermoplastic overmolding. The resulting sealing systems have combinations of properties rendering them superior and unique to profiles previously available. The elastomeric polymer profiles disclosed herein are particularly well suited for use in producing certain classes of vehicle sealing systems, glass run channel, door seal or belt line seal and vehicles using the profiles in combination with for instance, flock, thermoplastic or aluminum. Vehicles contemplated incude, but are not limited to passenger autos, trucks of all sizes, farm vehicles, trains, and the like.

In a car, there are different types of sealing with different functions, therefore constructed with different structure. For example the most common are door seal, glass run channel and belt line seal:

1. Door seal, where three different rubber compounds may be used. A microcellular profile is in contact with the car body frame, providing by compression, adequate sealing against water, air and aerodynamic noise. A metal carrier compound, generally rigidified by a flexible stamped metal co-extruded with the rubber, holds the sponge portion and is further gripped on the car body. Soft rubber lips inside the metal carrier provide a tight link between the rubber components and the metallic body frame of the car. Up to now, door seals have generally been manufactured by using EPDM type rubber generally without any other material addition.

2. Glass run channel is another profile generally composed of one type of rubber extruded in such form that the glass is guided during the rewinding operation and then insure good insulation when the glass is closed. Movement in the channel is generally facilitated by a flock deposit inside the rubber channel. This flock is adhered to the rubber with a curable cement, generally chloroprene based.

3. Inner or outer belt line seal is a rubber profile composed generally of two coextruded parts: one flexible portion against the glass and modified as described above to facilitate the motion of the glass, and one stiff portion rigidified generally with a metal, steel or aluminum coextruded with the rubber compound.

The improved adhesion is obtained either by compounding a chemically modified (functionalized) elastomeric polymer as described in the invention, with an elastomeric polymer, carbon black, plasticizers, curatives, and other additives known to those of ordinary skill in the art, or by coextruding a thin layer of a veneer formulated with the chemically modified elastomeric polymer. This elastomeric material substantially removes therefore the need for special surface pre-treatment necessary to obtain the required adhesion properties. It makes the fabrication process simpler and more economic for the fabricator, the adhesion performance more consistent, improving the overall quality of the part, improving also the economics by decreasing the quantity of defects and scrap.

Those skilled in the art will appreciate that numerous modifications to these preferred embodiments can be made without departing from the scope of the invention. For example, although extruded profiles based on functionalized elastomeric polymers are exemplified herein, the profiles may be made using combinations of other functionalized polymers and with other non-functionalized elastomeric polymers. To the extent our description is specific, it is solely for the purpose of illustrating preferred embodiments of our invention and should not be taken as limiting the present invention to these specific embodiments.

### Functionalized Ethylene, -Alpha-Olefin, Non-Conjugated Diene Terpolymer

The base ethylene, -alpha-olefin, non-conjugated diene terpolymer (hereinafter terpolymer or elastomeric terpolymer) used for embodiments of our invention include those containing ethylene, a C₃ or higher alpha-olefin, and a non-conjugated diene monomer. The preferred ethylene content is from about 35 to about- 85 weight percent, preferably from about 40 to- about 80 weight percent, more preferably from about 45- to about 75 weight percent. (For the remainder of this discussion phrases such as the copolymers ethylene content is at least 35 weight percent means: that the copolymer was formulated using 35 weight percent ethylene.) The preferred -alpha-olefins are selected from the group consisting of C₃, C₄, C₆, C₈, and higher molecular weight -alpha-olefins, or combinations thereof. The preferred non-conjugated diene is selected from the group consisting of 5-ethylidene-2-norbomene, 1,4-hexadiene, 1,6 octadiene, 5-methyl-1,4 hexadiene, 3,7-dimethyl-1,6-octadiene, vinylnorbomene, dicyclopentadiene or combinations thereof. The non-conjugated diene will be present in the range of from 1-15 weight percent, preferably 2-11 weight percent. The -alpha-olefin will make up the remainder of the EPDM, with percentages adding up to 100 weight percent.

The functionalized may take place through single grafting of functional unsaturated monomers or through grafting followed by post-modification of the grafted functionality.

The functionalized compositions can be synthesized by reacting the ethylene-higher -alpha-olefin terpolymer with an unsaturated organic compound. This functionalization may be accomplished by any technique known in the art such as those disclosed in U.S. Pat. No. 3,236,917; U.S. Pat. No. 4,950,541 and/or U.S. Pat. No. 5,194,509, which are incorporated herein by reference. Typically, the polymer to be grafted, the unsaturated organic compound and an optional free radical initiator are all introduced into a reaction zone, heated and or mixed and allowed to react. One of the many possible methods to graft the ethylene-higher -alpha-olefin terpolymer compositions would be introducing the polymer into a mixing device, such as a single or twin screw extruder or an internal mixer, heating the polymer until it is molten, injecting the unsaturated organic compound and the free radical initiator into the mixing device and mixing the components under high or low shear conditions. The unsaturated organic compounds may be added as a neat compound, as part of a master batch, or as a supported compound. The support is typically a polymer but may be any of the well known inorganic supports.

Typical free radical initiators include well known peroxides, such as dialkyl peroxides, (dicumylperoxide, 2,5-dimethyl-2,5-bis-(tert-butylperoxy) hexyne-3, tert-butylcumylperoxide, 2,5-dimethyl-2,5-bis-(tert-butylperoxy) hexane, diacylperoxide (dibenzoyl peroxide, dilauryl peroxide), peroxyesters (tert butyl peroxyacetate, tert-butyl peroxypivalate, peroxyketones, monoperoxycarbonates and azo compounds such as AIBN (azobisisobutyronitrile). Commercially available peroxides of these families are the Lupersol™, Luperox™, Trigonox™, and Perkadox™ products.

Unsaturated organic compounds containing at least one carbonyl group are those compounds containing at least one unsaturation and at least one carbonyl group (−C═O). Representative compounds include the carboxylic acids, anhydrides, esters and their salts, both metallic and non-metallic. Preferred compounds are compounds containing an alpha, beta-unsaturated conjugated carbonyl group. Preferred examples include maleic, fumaric, acrylic, methacrylic, itaconic, crotonic, a-methyl crotonic and cinnamic acids, their anhydride, ester and salt derivatives, as well as glycidylmethacrylate, glycidyl acrylate or other glycidyl compounds, hydroxyalkyl acrylates, hydroxyalkyl methacrylates, vinylpyridine, vinylpyrrolidone and vinyl pyrrole. Maleic anhydride is a preferred unsaturated organic compound.

The functionalized ethylene-higher -alpha-olefin terpolymer can also be the product of post reaction of the maleic anhydride functionalized ethylene-higher -alpha-olefin terpolymer with other chemicals containing amines, alcohols, thioalcohols or epoxides such as described in U.S. Pat. No. 5,424,367. A detailed list of reactants is given in this patent which is incorporated herein by reference.

The functionalized ethylene-higher -alpha-olefin terpolymer can also be produced by direct polymerization of ethylene, propylene or a higher -alpha-olefin comonomer, a non-conjugated diene and a functionalized diene. As polar groups are poisons of Ziegler-Natta catalysts, the functional groups have to be protected through reaction with tri ethyl aluminum prior to polymerization and the protective groups have to be removed via acidic hydrolysis. This technology allows synthesizing EPDM containing carboxylic acid groups, hydroxyl groups and amines (U.S. Pat. No. 4,987,200). Hydroxyl and amine functionalized EPDM can also be obtained through the use of metallocene catalysts (WO 97/49738). This technology is however limited to the production of aromatic alcohols and amines. The level of functionalization will be in the range of from about 0.1 to about 15 weight percent, preferably from about 0.5 to about 5 weight percent.

The functionalized ethylene-higher -alpha-olefin terpolymer can also be produced by polymerization of ethylene, -alpha-olefin, non-conjugated diene, selected olefinic ester, carboxylic acids and other monomers with selected transition metal compounds as described in WO 96/23010.

### Functionalized Ethylene, Alpha-Olefin Copolymer

The underlying copolymer contemplated is an ethylene -alpha-olefin copolymer (hereinafter copolymer or elastomeric copolymer) containing ethylene in the range of from about 5 to about 90 weight percent, preferably from about 10 to about 80 weight percent with the balance being -alpha-olefin to make up 100 weight percent. The -alpha-olefin will preferably be selected from the group consisting of propylene, butene-1, 4-methyl-1-pentene, hexene-1, octene-1, higher molecular weight -alpha-olefins and combinations thereof. The copolymer is distinguished from the diene terpolymer by the substantial absence of diene (less than 1 wt. %).

The functionalization may take place through single grafting of unsaturated comonomers or through grafting followed by post-modification of the grafted monomer.

The functionalized ethylene-higher -alpha-olefin copolymer compositions can be synthesized just as described above for the terpolymers.

Typical free radical agents include those discussed above in the terpolymer section.

Unsaturated organic compounds containing at least one carbonyl group are those compounds discussed above in the terpolymer section.

The functionalized ethylene-higher -alpha-olefin copolymer can also be the product of post reaction of the maleic anhydride functionalized ethylene-higher -alpha-olefin copolymer with other chemicals containing amines, alcohols, thioalcohols or epoxides such as described in U.S. Pat. No. 5,424,367. A detailed list of reactants is given in this patent.

The functionalized ethylene-higher -alpha-olefin copolymer can also be produced by direct polymerization of ethylene, propylene or a higher -alpha-olefin comonomer and a functionalized diene in much the same way as discussed for that of the terpolymer above.

The functionalized ethylene-higher -alpha-olefin copolymer can also be produced by polymerization of ethylene, -alpha-olefin, selected olefinic ester, carboxylic acids and other monomers with selected transition metal compounds as described in PCT publication WO 96/23010.

### Non-Functionalized Ethylene -Alpha-Olefin, Non-Conjugated Diene Terpolymer

The non-functionalized ethylene -alpha-olefin, non-conjugated diene terpolymers used for embodiments of our invention include those having ethylene contents of from about 35 to about 85 weight percent, preferably from about 40 to about 80 weight percent, more preferably from about 45 to about 75 weight percent. Preferred -alpha-olefins are selected from the group consisting of C₃, C₄, C₆ or C₈, higher molecular weight -alpha-olefins, and combinations thereof. The diene can be any non-conjugated-diene that can suitably incorporated into the polymer backbone but is preferably selected from 5-ethylidene-2-norbomene, 1,4-hexadiene, 1,6 octadiene, 5-methyl-1,4 hexadiene, 3,7-dimethyl-1,6-octadiene, vinylnorbomene, dicyclopentadiene, or combinations thereof. The non-conjugated diene will be present in the terpolymer in the range of from about 1 to about 15 weight percent, preferably from about 2 to about 11 weight percent. The -alpha-olefin will make up the remainder of the terpolymer, with percentages adding up to 100 weight percent.

These non-functionalized terpolymers are distinguished from the functionalized polymers described above in that they are substantially free of functionalization and have a 100% hydrocarbon composition.

### Non-Functionalized Ethylene -Alpha-Olefin Copolymer

The non-functionalized ethylene -alpha-olefin copolymers used for embodiments of our invention include those having ethylene contents of 40-85 weight percent preferably 45-80 weight percent more preferably 50-75 weight percent -alpha-olefins selected from the group consisting of C₃, C₄, C₆ or C₈, higher molecular weight -alpha-olefins, and combinations thereof.

These non-functionalized copolymers are distinguished from the functionalized polymers described above in that they are substantially free of functionalization and have a 100% hydrocarbon composition.

### Combinations of Functionalized and Non-Functionalized Elastomeric Polymers

As previously discussed, while either or both functionalized co or terpolymers can be used in the sealing profiles, they may also be blended with non-functionalized co or terpolymers or combinations thereof.

Contemplated are the following combinations:

a) Functionalized elastomeric copolymer

b) Functionalized elastomeric copolymer and non-functionalized elastomeric copolymer;

c) Functionalized elastomeric terpolymer;

d) Functionalized elastomeric copolymer and functionalized elastomeric terpolymer;

e) Functionalized elastomeric terpolymer and non-functionalized elastomeric terpolymer;

f) Functionalized elastomeric terpolymer and non-functionalized elastomeric copolymer;

g) Functionalized elastomeric terpolymer, non-functionalized elastomeric terpolymer and non-functionalized elastomeric copolymer;

h) Functionalized elastomeric copolymer and non-functionalized elastomeric terpolymer;

i) Functionalized elastomeric copolymer, non-functionalized elastomeric copolymer and non-functionalized elastomeric terpolymer;

j) Functionalized elastomeric copolymer, functionalized elastomeric terpolymer and non-functionalized elastomeric terpolymer;

k) Functionalized elastomeric copolymer, functionalized elastomeric terpolymer and non-functionalized elastomeric copolymer;

l) Functionalized elastomeric copolymer, functionalized elastomeric terpolymer, non-functionalized elastomeric terpolymer and non-functionalized elastomeric copolymer.

In all of these cases crystalline polyolefins are substantially absent. Additionally in each of, c) −1) the polymers or polymer combinations can be sulfur or peroxide cured whereas in a) and b), the polymers or polymer combinations must be peroxide cured. The cure will be full, that is to say the full cure creates a thermosetting article from compounds based on the above a) −1) combinations. By thermoset we intend that the finished cured polymer, polymer blend and compounds based on each, cannot be remasticated or replasticized in any way.

### Sulfur Curing

Any and all systems contemplated as sulfur cured embodiments of our invention may be substantially sulfur vulcanized. Vulcanization is described in Chapter 7 of Science and Technology of Rubber, Academic Press Inc., 1978. By sulfur cured, we intend that there be substantially no peroxide or other chemical alternatively used to cure articles included in embodiments of our invention. By elemental chemical analysis method such as Schoeninger method, microcoulometry, Inductive Coupled Plasma Atomic Emission Spectroscopy, Dietert sulfur method., can be used to determine sulfur content in a rubber compound.

### Peroxide Curing

Any and all systems contemplated as peroxide cured embodiments of our invention may be substantially peroxide vulcanized. Vulcanization is described in Chapter 7 of Science and Technology of Rubber, Academic Press Inc., 1978.

### Fully Cured

Whether sulfur or peroxide cured, the vehicle sealing systems described herein are preferably substantially fully cured and not considered partially cured. By fully cured we intend that the cured parts are thermoset, that is the cured part can not be replasticized, nor melt reprocessable.

### Crystalline Polyolefin

In the vehicle sealing systems of our invention we intend that these systems be substantially free of crystalline polyolefins. By substantially free we intend that there be less than 5 weight percent, preferably less than 3 weight percent, more preferably 0 weight percent of a crystalline polyolefin. By non-crystalline polymer, we intend to use ethylene alpha olefin polymer having a heat of fusion below 30 cal/gram as measured by Differential Scanning Calorimetry (DSC), preferably below 25 cal/gram, most preferably below 20 cal/gram.

### Amounts of Constituents

In the fabricated articles of our invention, we contemplate that, while glass run channels made exclusively of functionalized polymers can be made, from an economic and processability standpoint, such systems will not be preferred. Rather, blends of non-functionalized ethylene -alpha-olefin, non-conjugated diene terpolymer and one or both of functionalized ethylene -alpha-olefin, non-conjugated diene terpolymer and or functionalized ethylene -alpha-olefin copolymers will be used. Such blends will contain in the range of from about 1 to about 90 weight percent functionalized ethylene -alpha-olefin, non-conjugated diene terpolymer and/or copolymer, preferably from about 3 to about 80 weight percent, with the balance made up of non-functionalized ethylene -alpha-olefin, non-conjugated diene terpolymer. Similarly for a blend of functionalized ethylene -alpha-olefin copolymer, such blends will contain in the range of from about 1 to about 90 weight percent functionalized ethylene -alpha-olefin copolymer preferably from about 3 to about 80 weight percent, with the balance made up of non-functionalized ethylene -alpha-olefin, non-conjugated diene terpolymer. Combination of non-functionalized ethylene -alpha-olefin, copolymer, non-functionalized ethylene -alpha-olefin, non-conjugated diene terpolymer, functionalized ethylene -alpha-olefin, non-conjugated diene terpolymer and functionalized ethylene -alpha-olefin copolymer can also be contemplated.

### Definition of Terms and Tests

| Parameter | Units | Test |
|---|---|---|
| Mooney Viscosity* | ML 1 + 4, 125° C., MU | ASTM D 1646 |
| (elastomeric polymer | Weight % | ASTM D 3900 |
| content | | |
| determination)* | | |
| Ethylene | | |
| Ethylidene Norbornene | Weight % | ASTM D 6047 |
| Mooney Viscosity | ML 1 + 4, 100° C., MU | ASTM D 1646 |
| (compound) | | |
| Mooney Relaxation | MU · sec. | ASTM D 1646 |
| (MLR) | | |
| Mooney Scorch time | Ts_{2, 5 or 10}, 125° C., minutes | ASTM D 1646 |
| Oscillating Disk | | ASTM D 2084 |
| Rheometer (ODR) @ | | |
| 180° C., ±3° arc | | |
| ML | dN · m | |
| MH | dN · m | |
| Ts2 | minute | |
| T₉₀ | minute | |
| Cure rate | dN · m/minute | |
| Physical Properties, | | |
| press cured 10 minutes | | |
| @ 180° C. | | |
| Hardness | Shore A | ISO 7619-1986 |
| 100% Modulus | MPa | ISO 37-1977 type 2 |
| Tensile Strength | MPa | ISO 37-1977 type 2 |
| Elongation at Break | % | ISO 37-1977 type 2 |
| Compression Set, | | |
| press cured 8 min.@ | | |
| 180° C. | | |
| 22 hrs/70° C./ | % | ISO 815-1972(E) |
| 25% deflection | | |
| Tear Resistance | kN/m | DIN 53 507 A |
| Substrate Adhesion | | |
| Flock (peeling at | N/mm | DBL 5575 |
| 100 mm/min) | | |
| PU coating (peeling | N/cm | Exxon test (see |
| at 100 mm/min) | | below) |

*ethylene, alph-alpha-olefin, diene monomer elastomeric polymer

Use of the terms parts per hundred parts rubber (phr) and the term parts per hundred elastomeric polymer, are considered equivalent for purposes of this application. Use of the term “compound” for purposes of this application includes the elastomeric polymer and one or more of the following ingredients.

Carbon black used in the reinforcement of rubber, generally produced from the combustion of a gas and/or a hydrocarbon feed and having a particle size from 20 nm to 100 nm for the regular furnace or channel black or from 150 to 350 nm for the thermal black. Level in the compound may range from 10 to 300 parts per 100 parts of elastomeric polymer (phr).

Processing oil, preferably paraffinic, is added to adjust both the viscosity of the compound for good processing and its hardness in the range of 50 to 85 Shore A. Preferably the hardness ranges from about 40 to about 95 Shore A. Level in the compound may vary from 0 to 200 parts per hundred of elastomeric polymer(phr).

Mineral filler can be used to dilute the compound. It is typically calcium carbonate used in quantities from 0 to 150 phr. Other mineral filler can be reinforcing fillers like silica, aluminum silicate, magnesium silicate and other well known by the one skilled in the art of rubber compounding.

Zinc oxide and stearic acid are added to activate the accelerators and attain a good crosslink density. Typical quantities are between 0 to 20 phr of zinc oxide and 0 to 5 phr of stearic acid.

Polyethylene glycol is also used as a process aid and to activate the vulcanizing effect. Typical quantities are between 0 to 10 phr. Typical type have a molecular weight between 100 and 10000.

Vulcanizing agents are used to cause the chemical reaction resulting in crosslinking the elastomer molecular chains. Typical are sulfur (0 to 10 phr), sulfur donor like thiuram disulfides (TetraMethylThiuramDiSulfide) and thiomorpholines (DiThioDiMorpholine) in the range of 0 to 10 phr.

Accelerators are used to reduce the vulcanization time by increasing the speed of the crosslinking reaction. They are typically thiazoles (2-MercaptoBenzoThiazole or MercaptoBenzoThiazol diSulfide), guanidines (DiPhenylGuanidine), sulfenamides (N-CyclohexylBenzothiazolSulfenamide), dithiocarbamates (ZincDiMethylDithioCarbamate, ZincDiEthylDithioCarbamate, ZincDiButylDithioCarbamate, . . . ), thioureas (1,3 diEthylThioUrea, . . . ) and other well known by the one skilled in the art of rubber compounding. All can be used in the range of 0 to 5 phr.

A rubber compounder or fabricator for automotive body parts will plasticize or masticate the elastomer while adding materials such as reinforcing materials, diluting fillers, vulcanizing agents, accelerators, and other additives which would be well known to those of ordinary skill in the art, to produce an elastomer compound for use in automotive sealing. Generally, such plasticization, mastication, and/or compounding, or both, takes place in a roll mill or an internal kneader, such as a Banbury mixer or the like. After compounding, the materials are then fed to a device which can meter the compound (often an extruder) and force (screw of an extruder, piston of a press) the compounded elastomer into molding cavities or dies for shaping and curing. Curing can take place in heated mold cavity or in heat transfering devices continuously like hot air oven, possibly coupled with microwave oven or bath containing a heated liquid salt medium.

Laboratory testing of adhesion of rubber to substrate are made with molded samples.

1. Flock deposit is performed through a device providing an electric field of 70 kV. Polyamide flock is directed on a hot rubber (about 100° C.) covered with the polyurethane adhesive and then cured in a hot air oven during a time such as the total curing time of both rubber and adhesive is equal to 10 minutes:

TABLE A

| | Cure Time, minute | | |
|---|---|---|---|
| | uncured rubber | Semi cured rubber | Fully cured rubber |
| Before flock | 0 | 5 | 7 |
| After flock | 10 | 5 | 3 |

Adhesion of flock onto thermoset compound is measured according to Daimler Benz specification DBL 5575. Adhesion is measured by peeling a wax layer of 2 mm adhered onto the flock at a a speed of 100 mm/min. The wax layer is applied by melting.

2. Adhesion of the polyurethane coating onto the thermoset compound is measured by peeling a fabric layer adhered onto the coating. The polyurethane coating is applied manually on an uncured rubber compound with a ruler to get a 200 μm (micrometer) thick uniform film. The rubber compound is shaped in a 2 mm thick sheet by compression molding at 90° C. for 3 minutes. The preparation is then cured for 5 minutes at 180° C. in an oven. The adhesion testing is done by peeling at 100 mm/minute. A fabric (cotton) layer is adhered by a cyanoacrylate glue onto the cured coating. It will be used as one part to be clamped in the traction device (tensile tester) in order to measure the adhesion force, the other part being the cured rubber, clamped in a zone not containing any coating.

### EXAMPLES

In example 1, we show that the use of an EPDM elastomer grafted with maleic anhydride in an elastomeric compound used for the production of a glass run channel or belt line seal part flocked with polyamide fiber enhances significantly the adhesion of the polyamide flock to the elastomeric surface, measured according to the DBL 5575 specification. When a polyurethane prepolymer is used as an adhesive layer (e.g. Flocksil™ 1501 from Henkel), the functionalized EPDM can be used single in the formulated compound or in blend with a non-functionalized EPDM. However, the best results are obtained when only functionalized EPDM is used in the compound (compound 3).

The flocking process consists generally of, 1) abrading the surface of the elastomeric compound, 2) coating it with a solvent based curable polyurethane adhesive, 3) deposing the polyamide flock under a about 70000V electrical field and 4) curing the adhesive in a hot air or an infra-red oven. In some instances, the use of a maleic anhydride grafted EPDM in the elastomeric compound could enable a fabricator to by-pass the abrading step of the process and provide even superior flock adhesion to the elastomeric substrate.

More interestingly, the addition of an hydroxyl functionalized ethylene -alpha-olefin copolymer (could also be an amine functionalized ethylene -alpha-olefin copolymer) to a thermoset compound allows a dramatic increase in the adhesion to a low friction coating (bi-component paint based on urethane polymer crosslinked by 4,4-diphenylmethane diisocyanate available for example from Sakai Chemical Industrial Company). The coating process consists generally of spraying a PU based preparation containing the reactive ingredients on an EPDM profile surface. The profile can be uncured (spray after extruder), semi-cured (spray after a first series of hot air ovens) or fully-cured (spray off-line after complete extrusion and curing process).

As illustrated in Example 2, the addition of 15 phr of Exxelor ™ MDEX 96-6, an hydroxyl functionalized ethylene butene copolymer (available from Exxon Chemical Company) to a reference sulfur curable EPDM compound (compound. 8 in Table IV) allows increase of the adhesion by a factor of 5 versus the unmodified reference compound (results in Table V) and shifts the adhesion failure mode from adhesive to cohesive (rubber stock failure).

It is anticipated that these functionalized ethylene -alpha-olefin copolymers or terpolymers will be of use in other applications where increased surface polarity is needed or when improved adhesion onto thermoplastic substrates having functional group susceptible of reacting with the modified copolymer is wanted. cl Example 1

TABLE 1

| Compound Batch | Compound 1 | Compound 2 | Compound 3 |
|---|---|---|---|
| EPDM Vistalon ™ 7500 | 100 | 50 | |
| EPDM grafted with 1% MA | | 50 | 100 |
| FEF N550 | 110 | 110 | 110 |
| APF N683 | 50 | 50 | 50 |
| Flexon ™ 876 | 85 | 85 | 85 |
| Zinc Oxide | 5 | 5 | 5 |
| Stearic Acid | 1 | 1 | 1 |
| PEG 3350 | 2 | 2 | 2 |
| Calcium Oxide | 5 | 5 | 5 |
| Sulfur | 1 | 1 | 1 |
| MBT | 1.5 | 1.5 | 1.5 |
| TMTDS | 0.8 | 0.8 | 0.8 |
| DPTT | 0.8 | 0.8 | 0.8 |
| ZDBDC | 0.8 | 0.8 | 0.8 |
| ZDEDC | 0.8 | 0.8 | 0.8 |
| Total Weight | 363.7 | 363.7 | 363.7 |
| Mooney Viscosity | | | |
| ML (1 + 4), 100° C., M.U | 65 | 96 | 144 |
| ODR ±3° arc, 180° C. | | | |
| ML, dN.m | 9 | 12 | 18 |
| MH, dN.m | 67 | 61 | 61 |
| MH-ML, dN.m | 58 | 49 | 43 |
| Ts₂, min | 0.65 | 1.0 | 0.9 |
| T₉₀, min | 2.5 | 3.2 | 3.4 |
| Cure rate dN.m/min | 76 | 38 | 26 |

TABLE II

| | Compound 1 | Compound 2 | Compound 3 |
|---|---|---|---|
| Physical Properties, | | | |
| press cured 5 min. @ | | | |
| 180° C. | | | |
| Hardness, shore A | 71 | 71 | 71 |
| 100% Modulus, MPa | 4.7 | 4.2 | 4.7 |
| Tensile Strength, MPa | 11 | 9.6 | 9.2 |
| Elongation, % | 255 | 265 | 215 |
| Compression Set | | | |
| 22 hrs/70° C./25% def, % | 23 | 53 | 47 |
| Flock Adhesion Force - DBL | | | |
| 5575 | | | |
| Non-abraded surface, N/mm | 0.23 | 0.8 | 3.5 |
| Abraded surface, N/mm | 0.57 | 1.0 | 3.9 |

### Example 2

TABLE III

| COM- | Compd. | Compd. | Compd. | Compd. | Compd. | Compd. |
|---|---|---|---|---|---|---|
| POUND | 4 | 5 | 6 | 7 | 8 | 9 |
| VISTALON ™ | 100 | 100 | 100 | 100 | 100 | 100 |
| 9500 | | | | | | |
| Exxelor ™ | 0 | 3 | 5 | 10 | 15 | 20 |
| MDEX 96-6 | | | | | | |
| FEF N-550 | 140 | 140 | 140 | 140 | 140 | 140 |
| FLEXON ™ | 80 | 80 | 80 | 80 | 80 | 80 |
| 815 | | | | | | |
| Calcium | 60 | 60 | 60 | 60 | 60 | 60 |
| Carbonate | | | | | | |
| ZnO | 6 | 6 | 6 | 6 | 6 | 6 |
| Stearic Acid | 1 | 1 | 1 | 1 | 1 | 1 |
| Calcium Oxide | 8 | 8 | 8 | 8 | 8 | 8 |
| Sulfur | 1.8 | 1.8 | 1.8 | 1.8 | 1.8 | 1.8 |
| MBTS 80% | 0.63 | 0.63 | 0.63 | 0.63 | 0.63 | 0.63 |
| CBS | 1 | 1 | 1 | 1 | 1 | 1 |
| ZDBDC | 0.8 | 0.8 | 0.8 | 0.8 | 0.8 | 0.8 |
| DPG | 0.5 | 0.5 | 0.5 | 0.5 | 0.5 | 0.5 |

MONSANTO ODR, 180° C., ± 3° ARC

| | | | | | | |
|---|---|---|---|---|---|---|
| ML, dNm | 6.9 | 7.4 | 7.4 | 7.9 | 8 | 7.8 |
| MH, dNm | 51 | 55 | 56 | 57 | 54 | 52 |
| Ts₂, min | 0.58 | 0.58 | 0.65 | 0.65 | 0.67 | 0.76 |
| Tc₉₀, min | 1.7 | 1.7 | 1.8 | 1.8 | 1.8 | 1.9 |
| Peak Rate | 79 | 89 | 89 | 89 | 80 | 83 |
| (dNm/min) | | | | | | |

MOONEY VISCOSITY, ML 1 + 4, 100° C.,

| | | | | | | |
|---|---|---|---|---|---|---|
| MU | 60 | 63 | 62 | 65 | 65 | 64 |

MOONEY SCORCH, MS 125° C.,

| | | | | | | |
|---|---|---|---|---|---|---|
| Ts₂, min | 4.3 | 4.3 | 4.4 | 4.4 | 4.5 | 6 |
| Ts₅, min | 5.1 | 5.2 | 5.3 | 5.3 | 5.3 | 7.2 |
| Ts₁₀, min | 5.5 | 5.5 | 6.1 | 6.1 | 6.2 | 8.2 |

TABLE IV

| COMPOUND | Compd. 4 | Compd. 5 | Compd. 6 | Compd. 7 | Compd. 8 | Compd. 9 |
|---|---|---|---|---|---|---|
| Peel test at 100 | 6.2 | 7.7 | 9.9 | 11.9 | 31.7 | 84.8 |
| mm/minute | | | | | | |
| Peel strength (N) | 2.5 | 3.1 | 4 | 4.8 | 12.7 | 33.9 |
| Peel strength | adhesive | adhesive | adhesive | adhesive | adhesive/ | cohesive |
| (N/cm) | delamin- | delamin- | delamin- | delamin- | cohesive | in rubber |
| Failure mode | ation | ation | ation | ation | | stock |

### Conclusion

The present invention has been described in considerable detail with reference to certain preferred versions thereof, other versions are possible. For example, while glass run channels, door seal and belt line seals have been exemplified, other uses are also contemplated. Therefore, the spirit and scope of the appended claims should not be limited to the description of the preferred versions contained herein.

1. A vehicle sealing system formed from a compound comprising a cured thermoset polymer, having a heat of fusion below about 30 cal/gram, wherein the cured thermoset polymer comprises at least one functionalized elastomeric polyolefin functionalized with one or more polar groups.

2. The vehicle sealing system of claim 1, wherein the functionalized elastomeric polyolefin ranges from about 1 to about 90 weight % based on the total polymer weight of the compound.

3. The vehicle system of claim 2 wherein the functionalized elastomeric polyolefin is selected from:
a) one of more elastomeric terpolymers of ethylene, C₃ or higher alpha-olefins and non-conjugated dienes, wherein the ethylene content of the terpolymers is from about 35 to about 85 weight %; or
b) one or more elastomeric copolymers of ethylene and C₃ or higher alpha-olefins, wherein the ethylene content of the copolymer is from about 5 to about 90 weight %; or
c) a mixture of a) and b).

4. The vehicle sealing system of claim 3, wherein the ethylene content of the terpolymers is from about 40 to about 80 weight %.

5. The vehicle sealing system of claim 3, wherein the ethylene content of the copolymers is from about 10 to about 80 weight %.

6. The vehicle sealing system of claim 1 wherein the polar groups are one or more members selected from carboxylic acid, anhydride, hydroxyl, epoxide, and amine functionality.

7. The vehicle sealing system of claim 3 wherein the content of the non-conjugated dienes range from about 1 to about 15 weight % based on the total weight of the terpolymer.

8. The vehicle sealing system of claim 3 wherein the cured polymer compound further comprises from about 10 to about 99 weight % of one or more additional elastomeric polyolefins containing based on the total polymer weight of the polymer.

9. The vehicle sealing system of claim 8 wherein the additional elastomeric olefin comprises one or more components independently selected from:
a) elastomeric terpolymers of ethylene, C₃ or higher alpha-olefins and non-conjugated dienes, wherein the ethylene content of the terpolymers is from about 35 to about 85 weight %; or
b) elastomeric copolymers of ethylene and C₃ or higher alpha-olefins, wherein the ethylene content of the copolymer is from about 5 to about 90 weight %.

10. The vehicle sealing system of claim 3 wherein said cured thermoset polymer compound is substantially fully cured.

11. The vehicle sealing system of claim 101 wherein said a cured thermoset polymer compound is cured by a sulfur curing system, a peroxide curing system, or a combination thereof.

12. The vehicle sealing system of claim 3 wherein said system is a door seal, a glass run channel, an inner belt line seal, or and outer belt line seal.

13. The vehicle sealing system of claim 3 wherein said sealing system includes one or more additional elements selected from flocking, coloring, low friction coating, thermoplastic veneer, and overmolding.

14. A vehicle that contains the sealing system of claim 13.

15. A cured thermoset polymer compound having a heat of fusion below about 30 cal/gram and comprising at least one functionalized elastomeric polyolefin functionalized with one or more polar groups.

16. The cured thermoset polymer compound of claim 15, wherein the functionalized elastomeric polyolefin ranges from about 1 to about 90 weight % based on the total polymer weight of the compound.

17. The cured thermoset polymer compound of claim 16 wherein the functionalized elastomeric polyolefin is selected from:
a) one or more elastomeric terpolymers of ethylene, C₃ or higher alpha-olefins and non-conjugated dienes, wherein the ethylene content of the terpolymers is from about 35 to about 85 weight %; or
b) one or more elastomeric copolymers of ethylene and C₃ or higher alpha-olefins, wherein the ethylene content of the copolymer is from about 5 to about 90 weight %; or
c) a mixture of a) or b).

18. The cured thermoset polymer compound of claim 17, wherein the ethylene content of the terpolymers is from about 40 to about 80 weight %.

19. The cured thermoset polymer compound of claim 17, wherein the ethylene content of the copolymers is from about 10 to about 80 weight %.

20. The cured thermoset polymer compound of claim 17 wherein the cured polymer compound further comprises one or more additional elastomeric polyolefins containing from about 10 to about 99 weight % based on the total weight of the polymer.

21. The cured thermoset polymer compound of claim 20 wherein the additional elastomeric olefin comprises one or more components selected from:
a) one or more elastomeric terpolymers of ethylene, C₃ or higher alpha-olefins and non-conjugated dienes, wherein the ethylene content of the terpolymers is from about 35 to about 85 weight %; or
b) one or more elastomeric copolymers of ethylene and C₃ or higher alpha-olefins, wherein the ethylene content of the copolymer is from about 5 to about 90 weight %; or
c) a mixture of a) and b).

22. An article comprising the polymer compound of claim 21 bonded to at least one element.

23. The article of claim 22 wherein the element is a laminated, molded, or coextruded substrate or layer.

24. The article of claim 22 wherein the element is a thermoplastic element.

25. The article of claim 24 wherein the thermoplastic element is an elastomer.

26. The article of or claim 22 wherein the element is a coating.

27. The article of claim 26 wherein the coating is polyurethane.
